(19) United States
(12) Patent Application Publication
(10) Pub. No.: US 2017/0261637 A1
(43) Pub. Date: Sep. 14, 2017

(54) APPARATUS AND METHODS OF FLUID-FILLED FRACTURE CHARACTERIZATION

(71) Applicant: Halliburton Energy Services, Inc., Houston, TX (US)

(72) Inventors: Glenn A. WILSON, Singapore (SG); Burkay DONDERICI, Houston, TX (US)

(21) Appl. No.: 15/528,499

(22) PCT Filed: Dec. 19, 2014
(86) PCT No.: PCT/US2014/071420

§ 371 Date: May 19, 2017

(51) Int. Cl. G01V 3/38; E21B 49/00; G01V 3/28

(52) U.S. Cl. CPC G01V 3/38; G01V 3/28; E21B 49/00

(57) ABSTRACT

Various embodiments include apparatus and methods providing a tool to characterize a fracture in formation. Such a tool can use electromagnetic logging data that can be acquired in a processing unit to operate on the data using a fracture model that represents a fracture by an electrically thin sheet. Additional apparatus, systems, and methods are disclosed.

### TECHNICAL FIELD

The present invention relates generally to apparatus and methods of measurement related to oil and gas exploration.

### BACKGROUND

In drilling wells for oil and gas exploration, understanding the structure and properties of the associated geological formation provides information to aid such exploration. Measurements in a wellbore, also referred to as a borehole, are typically performed to attain this understanding. However, the environment in which the drilling tools operate is at significant distances below the surface and measurements to manage operation of such equipment are made at these locations.

Logging is the process of making measurements via sensors located downhole, which can provide valuable information regarding the formation characteristics. For example, induction logging can utilize electromagnetic signals that can be used to make measurements. The responses from probing with electromagnetic signals can provide logs that represent measurements of one or more physical quantities in or around a well, where these measurements are a function of depth, time, or depth and time.

The characteristics of fluid-filled fractures in a formation are important to formation evaluation. A number of publications have been related to fracture characterization. In a typical a multi-component induction (MCI) tool workflow, electromagnetic (EM) data is acquired and a borehole correction is applied. The corrected data in some approaches has been inverted for a whole-space or layered earth model defined by a conductivity with uniaxial (or transversely isotropic) anisotropy. When a fluid-filled fracture is present, the measured EM fields typically cannot satisfy either whole-space or layered earth models. In recent works, fluid-filled fractures have been described by whole-space or layered earth models defined by a conductivity with biaxial anisotropy. This model assumes that the fluid-filled fractures in the formation are all perpendicular to the bedding plane of the formation. Such an assumption is not necessarily valid when interpreting well logs. Another approach includes a three-dimensional (3D) fracture model with variable length through a borehole. In this approach, the fracture model is limited in strike, dip, and plunge, and has a limited background conductivity model. Application of this technique is based on the fracture being aligned with the borehole axis. In other recent works, vertical fluid-filled fractures have been estimated from comparison of measured EM data with a suite of simulated finite-thickness sheet-like models. This model assumes that the fluid-filled fractures in the formation are parallel to the borehole axis. Again, this assumption is not necessarily valid when interpreting well logs. Another approach utilized a thin sheet earth model in a multi-step inversion method. This approach may be deficient for MCI workflows given the assumption of an electrically isotropic earth model.

The usefulness of such measurements may be related to the precision or quality of the information derived from such measurements. On-going efforts are being directed to improving techniques to enhance the precision or the quality of the information derived from such measurements.

### BRIEF DESCRIPTION OF THE DRAWINGS

FIG. 1A is a schematic diagram of an example tool structure of a multi-component induction tool, in accordance with various embodiments.

FIG. 1B is a schematic diagram of a configuration of one sub-array of the multi-component induction tool of FIG. 1A, in accordance with various embodiments.

FIG. 2A is a representation of a fracture in a borehole, in accordance with various embodiments.

FIG. 2B is a representation of an image of a fracture in a borehole in a volume of a formation having two different lithologies, in accordance with various embodiments.

FIG. 2C is a characterization of a fluid-filled structure, such as FIG. 2A, in accordance with various embodiments.

FIG. 3 is a flow diagram of features of an example method of processing earth formation related data in a processing unit, in accordance with various embodiments.

FIG. 4 is a representation of a three-dimensional earth model of a formation including a number of layers of anisotropic formation and two fluid-filled fractures, in accordance with various embodiments.

FIG. 5 is a flow diagram of an embodiment of a generalized inversion workflow for generating fracture network indicators, in accordance with various embodiments.

FIGS. 6A-6B are flow diagrams of thin sheet inversions for generating fracture network indicators, in accordance with various embodiments.

FIG. 7 is a block diagram of features of an example system operable to control an electromagnetic logging tool to conduct measurements in a borehole and to implement a processing scheme to determine a fluid-filled fracture characterization associated with the borehole, in accordance with various embodiments.

FIG. 8 is a schematic diagram of an example system at a drilling site, where the system is operable to control an electromagnetic logging tool to conduct measurements in a borehole and to implement a processing scheme to determine a fluid-filled fracture characterization associated with the borehole, in accordance with various embodiments.

### DETAILED DESCRIPTION

The following detailed description refers to the accompanying drawings that show, by way of illustration and not limitation, various embodiments in which the invention may be practiced. These embodiments are described in sufficient detail to enable those skilled in the art to practice these and other embodiments. Other embodiments may be utilized, and structural, logical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

Multi-component induction (MCI) logging tools are widely used to explore formation parameters, such as formation anisotropy, relative dip angle, boundaries, etc. Inversion processing of data to determine formation parameters can be performed according to a modeling approach for the formation. Inversion operations can include a comparison of measurements to predictions of a model such that a value or spatial variation of a physical property can be determined. In inversion, measured data may be applied to construct a model that is consistent with the data. For example, an inversion operation can include determining a variation of electrical conductivity in a formation from measurements of induced magnetic fields. Other techniques, such as a forward model, deal with calculating expected observed values with respect to an assumed model. Such models are electronic models realized in one or more processing units.

In zero-dimensional (0D) inversion, there is no variation of material parameters in the formation, such as in a homogenous formation. In one-dimensional (1D) modeling, there is variation in one dimension such as a formation of parallel layers. In two-dimensional (2D) modeling, there is variation in two dimensions and, in three-dimensional (3D) modeling, there is variation in three dimensions. In general, a coordinate system in which the above dimensions are defined can be Cartesian or cylindrical. In borehole applications, a cylindrical coordinate system is often used.

In various embodiments, systems and/or methods of acquiring, processing, and imaging wireline and/or logging-while-drilling (LWD) electromagnetic (EM) data acquired are implemented to characterize formation fractures about a borehole. A fluid-filled fracture near a borehole can be represented as an electrically thin sheet of arbitrary size, orientation, and conductance, embedded in formation which is described as a layered medium where each layer can be characterized by an anisotropic, frequency-dependent conductivity. The properties of the fluid-filled fractures and the formation can be inverted simultaneously or separately from using such a representation.

A thin sheet approximation, as taught herein, reduces a volume integral equation method to a surface integral equation method. This technique can provide for geometric flexibility, numerical accuracy, and computational efficiencies to interpret fluid-filled fractures from wireline and/or LWD EM data. Computational efficiencies can allow improved real-time processing and quick delivery of logs to customers, which can allow immediate manipulations on the logging plan and hence reduce overall cost of operation. There is no limit on the number of thin sheets (fractures) that can be included in such methods, or the type of anisotropy and/or layering present in the formation, as the integral equation formulation presented electromagnetically couples all thin sheets (fractures) together and with the formation. Hence, embodiments of methods to analyze formation fractures is not limited to a single thin sheet (fracture), but rather can be applied to multiple thin sheets (fractures).

The apparatus and techniques described herein pertain to fracture identification from wireline and/or LWD EM data. The techniques allow for a number of variations including, but not limited to: arbitrary transmitter and/or receiver positions, orientations, spacings, operating frequencies, and calibration factors; flexibility to define the formation as a background model as a layered medium with anisotropic conductivity; geometric flexibility to define fluid-filled fractures as thin sheets of arbitrary size, orientation; flexibility to define the conductance of the thin sheets, inclusive of permittivity and relaxation terms, as a frequency-dependent complex conductance; ability to include all coupling between the formation and multiple fluid-filled fractures; and ability to invert for any combination of model parameters, whether simultaneously or sequentially. The EM logging data can be inverted for fluid-filled fracture models to provide the fracture identification and characterization.

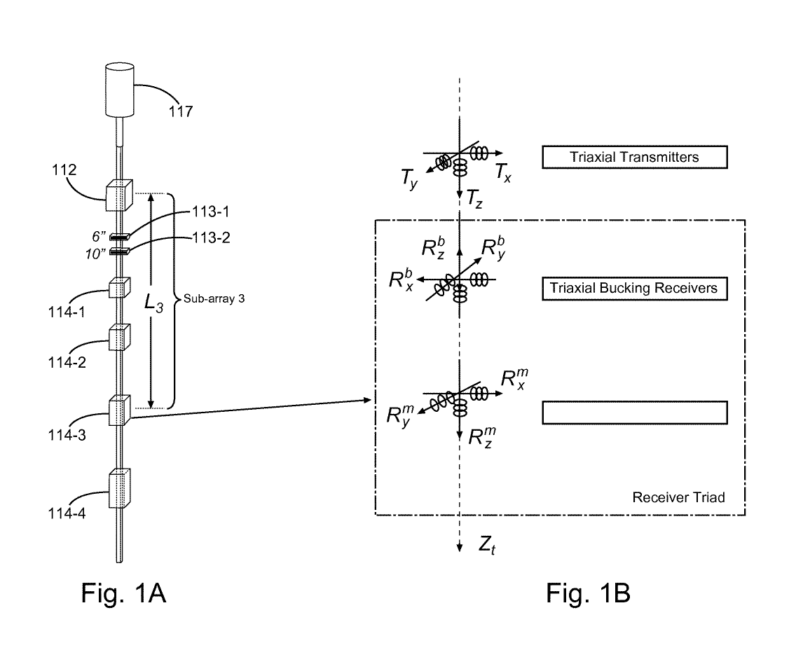

FIG. 1A is a schematic diagram of an example tool structure of a MCI tool. The MCI tool can include a transmitter triad 112, four receiver triads 114-1, 114-2, 114-3, and 114-4, as well as two conventional axial receivers 113-1 and 113-2. The conventional receivers 113-1 and 113-2 are located closest to the transmitter triad 112 and separated from the transmitter triad 112 by different distances. For example, one conventional axial receiver 113-1 can be separated from the transmitter triad 112 by 6 inches and the second conventional axial receiver 113-2 can be separated from the transmitter triad 112 by 10 inches. FIG. 1A shows the receiver triad 114-3, which can be a sub-array, separated from the transmitter triad by a distance L₃. The other receiver triads are separated from the transmitter triad by different distances. A MCI tool can be structured with a number of different sets of separation distances.

The MCI tool can include an electronic housing 117. The electronic housing 117 can include a control unit to selectively activate the transmitter triad 112 and to selectively acquire signals from the receiver triads 114-1, 114-2, 114-3, and 114-4, and the conventional axial receivers 113-1 and 113-2 in response to a probe signal transmitted from the transmitter triad 112. The electronic housing 117 can include a processing unit to operate on the received signals. The processing unit of the electronic housing 117 may also be arranged to process multi-component induction data derived from the received signals in a manner similar to or identical to techniques taught herein.

FIG. 1B is a schematic diagram of a configuration of one sub-array of the multi-component induction tool of FIG. 1A. This sub-array can be selectively controlled to acquire a response at one frequency. Other sub-arrays may be controlled to acquire a response at different frequencies. FIG. 1B shows an equivalent dipole model of the one sub-array arranged as a triad. It can be structured with triaxial components, with respect to three mutually orthogonal transmitters (Tₓ, T_{y}, T_{z}), including three mutually orthogonal main receivers (R^{m}ₓ, R^{m}_{y}, R^{m}_{z}) and three mutually orthogonal bucking/balancing receivers (R^{b}ₓ, R^{b}_{y}, R^{b}_{z}). The receiver triad 114-3 can include the main receivers (R^{m}ₓ, R^{m}_{y}, R^{m}_{z}) along with the bucking/balancing receivers (R^{b}ₓ, R^{b}_{y}, R^{b}_{z}). In this example, the transmitters are structured as transmitter coils that are collocated. The main receivers can be structured as receiver coils that are collocated, and the bucking receivers can be structured as receiver coils that are collocated. This tool structure enables the measurement of a nine-component voltage per frequency per triad in the logging tool's 3D coordinate system at each log depth. Though the following primarily describes embodiments of techniques, taught herein, for a MCI wireline tool, the application of these techniques is not limited to MCI wireline tools, such techniques can be applied to other EM logging tools and data collection methods.

Fluid-filled fractures can be simulated as electrically thin conductors, implying that the electric field is constant through the thickness of the conductor as the thickness of the conductor is very small relative to the wavelength of the EM fields. When valid, this thin-sheet approximation reduces a volume integral equation method to a surface integral equation method. This reduction can provide for geometric flexibility and computational efficiencies to interpret fluid-filled fractures from wireline and/or LWD EM data.

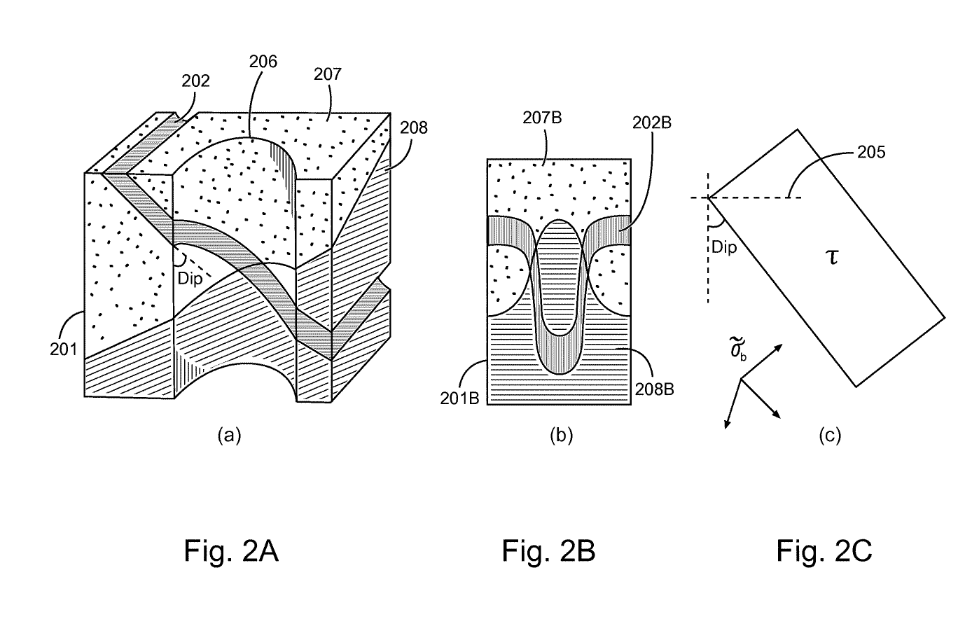

FIG. 2A is a representation of a fracture 202 in a borehole 206. This representation provides a more realistic presentation than typical representations used in conventional analysis. This example shows the borehole 206 in a volume 201 of a formation that includes different lithologies 207, 208. For example, the different lithologies 207, 208 may be sandstone and shale. The fracture 202 can be at a dip angle measured with respect to the borehole 206, and both the fracture 202 and borehole 206 may be at dip angles measured with respect to the formation bedding. The fracture 202 can be at any angle and orientation with respect to the borehole. FIG. 2B is a representation of an image of a fracture 202B in a borehole in a cross-section 201B of a volume of a formation having two different lithologies 207B, 208B. For example, the image may be an acoustic image. FIG. 2C is a characterization of a fluid-filled structure, such as for the fracture 202 of FIG. 2A, as a thin sheet 205. With borehole effects removed, the fluid-filled fracture can be characterized as a thin sheet 205 of conductance τ arbitrarily oriented in a background conductivity model \tilde{σ}_{b} that may be anisotropic, frequency-dependent, and defined in a different coordinate system to both the borehole and the fracture.

For an MCI tool, the multiple transmitters and receivers can be realized as orthogonal magnetic dipole transmitters and receivers at different spacings along the tool axis such as shown in FIGS. 1A-1B. The tool axis may be an axis of a cylindrical structure or other geometrical shape for a rod-like structure. The MCI tool can be at an arbitrary orientation with respect to the formation coordinate system. The borehole trajectory through the formation can be arbitrary.

The background conductivity model can include a layered medium. Each layer can be characterized by anisotropic conductivity σ_{b}(z) and/or permittivity ∈_{b}(z) and/or relaxation parameters that manifest as a frequency-dependent complex conductivity \hat{σ}_{b}(z). The anisotropy can be either isotropic, uniaxial (transversely isotropic, TI) or biaxial; and can be described as a 3×3 dyadic aligned with the formation coordinate system. Hence, it is possible to use a TI or biaxial anisotropic model.

The fracture model can include one or more thin sheets. There is no limit on the number of thin sheets (fractures) that can be included, as the integral equation formulation presented electromagnetically couples all thin sheets (fractures) together and with the (anisotropic) formation. Hence, embodiments taught herein are not to be read or interpreted as being for a single thin sheet (fracture), but rather for multiple thin sheets (fractures). Each thin sheet can be characterized by an isotropic conductivity σₛ and/or permittivity ∈ₛ and/or relaxation parameters and thickness t that in the limit t→0, manifest as a frequency-dependent complex conductance:

τ=[σₛ+iω∈ₛ]t=\tilde{σ}ₛt (1)

Note that at high frequencies, the conductance will have a significant imaginary part, related to the permittivity of the thin sheet. This implies that at high frequencies, dielectric analysis of the thin sheet can be performed to characterize fluid type, for example water and oil. Each thin sheet can have arbitrary dimensions, strike, dip, and plunge; each measured with respect to the formation coordinate system. In this model, the thin sheets (fractures) can have an arbitrary orientation with respect to each other, to the formation, and to the MCI tool.

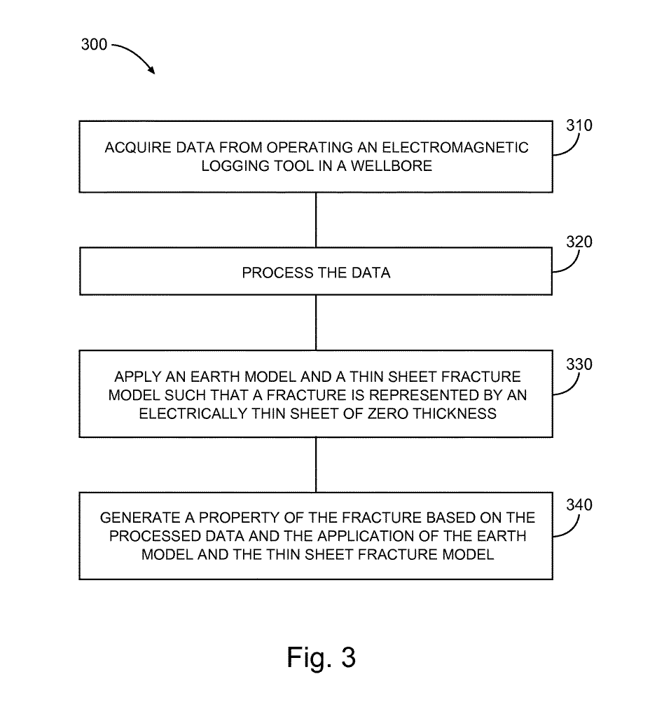

FIG. 3 is a flow diagram 300 of features of an embodiment of an example method of processing earth formation related data in a processing unit. The processing includes analyzing a fracture in an earth formation. At 310, data is acquired from operating an electromagnetic logging tool in a borehole. The data, or portions of the data, may be collected at an interface associated with the processing unit and the electromagnetic logging tool providing the data for direct use by the processing unit. The data, or portions of the data, may be collected at an interface associated with the processing unit and a memory system, such as a database, for processing by the processing unit. At 320, the data is processed. The processing can include adjusting the data to remove borehole effects or other artifacts associated with the data collection via the electromagnetic logging tool. At 330, an earth model and a thin sheet fracture model are applied in the processing unit such that a fracture is represented by an electrically thin sheet of zero thickness.

At 340, a property of the fracture generated based on the processed data and the application of the earth model and the thin sheet fracture model. A number of processing techniques can be used with respect to conducting inversions at different stages of processing. A method, similar or identical to the method of flow diagram 300, can include generating a fracture network indicator and/or properties of the fracture network, where the fracture network includes the fracture. A fracture network is at least one (often more) actual fractures in a formation. A fracture network may consist of fractures that emanate from the same source. The source may be localized (e.g., hydraulic fractures), or regional (e.g., tectonics). A fracture network indicator is a quantitative metric of the presence of fractures in a formation. If the indicator is zero (or small), there is a low likelihood of a fracture or fracture network being present. If the indicator is large, there is a high likelihood of at least one fracture or fracture network being present. A fracture format indicator can take the form of an “effective fracture,” which can be represented by at least one thin sheet. The full complexity of the fracture may not be captured, but the bulk response may be captured. Thus, matching the indication can be used to indicate that a fracture or fracture network is present. After acquiring and processing the data, applying the earth model and the thin sheet fracture model can be conducted in real-time. The earth model and the thin sheet fracture model can be stored and updated in the processing unit or in a memory system accessible by the processing unit.

A method, similar or identical to the method of flow diagram 300, can include, in each of a number of iterations, comparing the processed data and an iterative result of applying the earth model and the thin sheet fracture model with respect to a convergence criterion. Applying the earth model and the thin sheet fracture model can include cascading stages from a 1D resistivity inversion to a 1D biaxial resistivity inversion to a multiple thin sheets inversion based on results of comparison with convergence criterion in each of the stages.

A method, similar or identical to the method of flow diagram 300, can include parameterizing the earth model and the thin sheet fracture model with respect to one or more biaxial conductivities or one or more apparent conductivities and with respect to one or more electrically thin sheets, each thin represented having zero thickness; and inverting the processed data for the parameterized earth model and the thin sheet fracture model. Inverting can include simultaneous inversion with respect to the parameterized earth model and the thin sheet fracture model or sequential inversion with inversion with respect to the parameterized earth model followed by inversion with respect to the thin sheet fracture model.

In various embodiments, methods, similar or identical to the method of flow diagram 300 and the methods discussed above, may include a number of different functions, which may be conducted individually in any of these methods or in combinations of these functions. Generating a property of the fracture can include estimating one more of conductivity of the fracture, thickness of the fracture, dip angle of the fracture, or azimuthal orientation of the fracture. Applying the thin sheet fracture model in a processing unit can include operating the processing unit according to surface integrals using a spectral technique. An example of a spectral technique to process the surface integrals may include decomposing the scattering matrix of the thin sheet integral equation via a spectral decomposition, such as singular value decomposition. The largest singular values and corresponding eigenvectors may be stored and the remainder discarded; such that the scattering matrix can be approximated by the most relevant/important singular values and corresponding eigenvectors. This may involve truncating or damping the singular values. Methods of approximating the singular values, such as Lanczos algorithms, may also be used.

Applying the thin sheet fracture model can include dividing one or more thin sheets into a number of cells, each cell of constant conductance and each thin sheet representing a fracture. Applying the earth model can include applying a 1D whole-space earth model or a 1D layered earth model, the earth model containing one or more isotropic conductivity, uniaxial anisotropic conductivity, or bi-anisotropic conductivity. Applying the earth model and the thin sheet fracture model can include using processed data and applying the earth model and the thin sheet fracture model for a window of a selected volume of the earth model. Using processed data and applying the earth model and the thin sheet fracture model for the window of the selected volume of the earth model can include performing an inversion of the processed data to generate an updated earth model and thin sheet fracture model.

Methods, similar or identical to the method of flow diagram 300 and the methods discussed above, may include a number of other functions, which may be conducted individually in any of these methods or in combinations of these functions. Methods can include identifying a number of fractures using the thin sheet fracture model and estimating one or more fluid types in each fracture of the number of fractures based dielectric analyses of a complex conductance of each sheet representing a fracture. Methods can include operating the electromagnetic logging tool in the borehole with an electromagnetic contrast enhancing agent filing a number of fractures probed, providing data included in the acquired data. Methods can include performing a time-lapse analysis on the acquired data, the acquired data including data from two or more electromagnetic surveys conducted in the borehole at different times. For example, one measurement can be performed before a hydraulic fracturing (or “fracking”) operation, and one after. Methods analyzing one or more fractures using a thin sheet fracture model in which a fracture is represented by an electrically thin sheet of zero thickness can be conducted using parallel processing. Other processing functions can be conducted in methods, similar or identical to the method of flow diagram 300, as taught herein.

In various embodiments, a non-transitory machine-readable storage device can comprise instructions stored thereon, which, when performed by a machine, cause the machine to perform operations, the operations comprising one or more features similar to or identical to features of methods and techniques described herein. The physical structure of such instructions may be operated on by one or more processors. Executing these physical structures can cause the machine to perform operations to acquire data from operating an electromagnetic logging tool in a borehole; to process the data; to apply an earth model and a thin sheet fracture model in the processing unit such that a fracture is represented by an electrically thin sheet of zero thickness; and to generate a property of the fracture based on the processed data and the application of the earth model and the thin sheet fracture model. The instructions can include steps to operate an electromagnetic logging tool having one or more transmitters and one or more receivers to provide data to a processing unit in accordance with the teachings herein. Further, a machine-readable storage device, herein, is a physical device that stores data represented by physical structure within the device. Examples of machine-readable storage devices can include, but are not limited to, read only memory (ROM), random access memory (RAM), a magnetic disk storage device, an optical storage device, a flash memory, and other electronic, magnetic, and/or optical memory devices.

In various embodiments, a system can comprise a tool structure and a processing unit to process data from operating the tool structure. The tool structure can be an electromagnetic logging tool, such as but limited to an MCI tool structure, having a transmitter array and a plurality of receiver arrays, where the electromagnetic logging tool is capable of operating in a wellbore. For example, an implemented MCI tool can include the plurality of receiver arrays structured with coils arranged in a plurality of receiver triads disposed axially on the multi-component induction tool and the transmitter array structured with coils arranged in a transmitter triad disposed axially on the MCI tool, where the receiver triads are at different distances from the transmitter triad. The processing unit can be structured: to acquire data from operating an electromagnetic logging tool in a borehole; to process the data; to apply an earth model and a thin sheet fracture model in the processing unit such that a fracture is represented by an electrically thin sheet of zero thickness; and to generate a property of the fracture based on the processed data and the application of the earth model and the thin sheet fracture model.

The processing unit can be structured to perform processing techniques similar to or identical to the techniques discussed herein. The processing unit may control selective activation of the transmitters and acquisition of signals from the receivers. Alternatively, a control unit can be used to control and manage the transmitters and receivers. The processing unit can be configured to process the acquired signals and process data related to or generated from the acquired signals. The processing unit may be arranged as an integrated unit or a distributed unit. The processing unit can be disposed at the surface of a borehole to process multi-component induction data from operating the tool structure downhole. The processing unit be disposed in a housing unit integrated with the tool structure or arranged downhole in the vicinity of the tool structure.

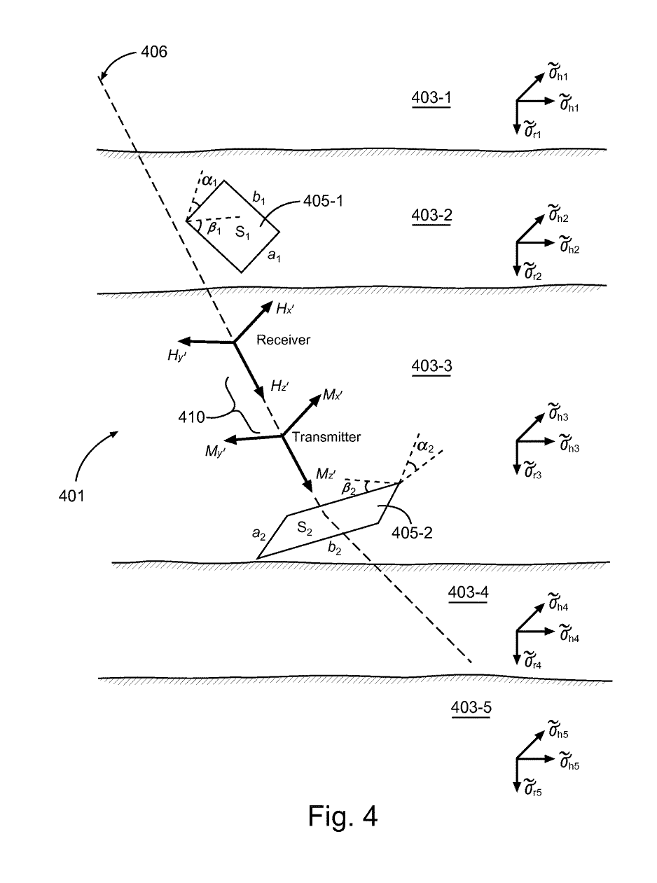

FIG. 4 is a representation of a 3D earth model of a formation 401 including layers 403-1, 403-2, 403-3, 403-4, and 403-5 of anisotropic formation and fluid-filled two fractures. The fluid-filled fractures can be represented as thin sheets 405-1 and 405-2 with conductance. An induction logging tool 410 follows a borehole trajectory 406 in the formation 401, where the formation 401 can be represented by as a layered medium with anisotropic conductivity. A model can be defined by the following model parameters. For the instrument, transmitter and receiver positions and orientations can be defined with respect to the formation. In FIG. 4, the transmitters are represented as magnetic moments M_{X}, M_{Y}, and M_{Z} and the receivers are represented as magnetic fields H_{X}, H_{Y}, and H_{Z}. For each layer, the model parameters may include depth (to top of layer), thickness, conductivity (for example, horizontal conductivity ∈ₕ and vertical conductivity σᵥ), and permittivity (for example, horizontal permittivity ∈ₕ and vertical permittivity ∈ᵥ). Layers 403-1, 403-2, 403-3, 403-4, and 403-5 can be referenced with respect to coordinates σₕᵢ and σᵥᵢ, i=1, 2, 3, 4, 5 for the corresponding layer. For each thin sheet, the model parameters may include position, depth, length, width, strike, dip, plunge, and conductance. For thin sheet 405-1, length b₁ and width a₁ defines an area S₁ with strike α₁ and dip β₁. For thin sheet 405-2, length b₂ and width a₂ defines an area S₂ with strike α₂ and dip β₂. Strike and dip values can be provided relative to formation coordinates of a formation coordinate system. Alternatively, other coordinate systems can be used such as, but not limited to, a global coordinate system, a borehole coordinate system, a tool coordinate system, or a fracture coordinate system. Measurements taken in the tool coordinate system may be transformed into the formation coordinate system, for example, by appropriate Euler rotations. Parameters or data from the other coordinate systems may also be appropriately transformed into the formation coordinate system.

As is known, the electric E and magnetic H fields due to an extraneous source in the presence of a thin sheet in a layered medium can be given by:

E(r′)=E^{b}(r′)−iωμ₀∫_{A}Ĝₛ(r′,r)·J^{s}(r)dA=E^{b}(r′)−iωμ₀∫_{A}Ĝₛ(r′,r)Δτ(r)E^{s}(r)dA, (2)

H(r′)=H^{b}(r′)−iωμ₀∫_{A}Ĝₛ(r′,r)·J^{s}(r)dA=H^{b}(r′)−iωμ₀∫_{A}Gₛ(r′,r)·Δτ(r)E^{s}(r)dA, (3)

where Δτ is the anomalous conductance of the thin sheet, E^{s} is the tangential component of the electric field in the thin sheet, and Ĝₛ are the electric or magnetic Green's functions for the background conductivity model Ĝ_{E,H} that reduces to 2×2 dyadics through successive rotations about the strike α and dip β angles:

Ĝₛ(r′,r)=R^{T}Ĝ_{E,H}R, (4)

where R is the rotation matrix:

$$R = [ \begin{matrix}cos α & - sin α cos β \\ sin α & cos α cos β \\ 0 & sin β\end{matrix} ] . \qquad ( 5 )$$

The extension to solving for multiple thin sheets, that is, multiple fractures, can be achieved by expanding the quantities in equations (2) and (3); in particular, the Green's tensor Gₛ(r′,r) can include the coupling coefficients between the scattering currents J^{s}(r) of the multiple thin sheets.

Considering only the tangential components of the electric field on the thin sheets, equation (3) reduces to a Fredholm integral equation of the second kind when r′ is on the thin sheet:

E^{s}(r′)=E^{b}(r′)−iωμ₀∫_{A}Ĝₛ(r′,r)·J^{s}(r)dA=E^{b}(r′)−iωμ₀∫_{A}Ĝₛ(r′,r)·Δτ(r)E^{s}(r)dA. (6)

To solve equation (6), the Green's tensors may impose a significant numerical instability, since every element is divided by a background conductivity term, for example, 1/σ_{b} for isotropic layers, 1/σ_{h,v} for uniaxial anisotropic layers, 1/σ_{x,y,z} for biaxial anisotropic layers, etc. To avoid this problem, the scattering currents on the thin sheets can be decomposed as the sum of the divergence-free induction (vortex) current part and the curl-free conduction current (or current channeling) part using two scalar potentials, ψ and φ. For example, in an isotropic layer:

J^{s}=∇ₛ×(\hat{c}ψ)+iωμₒσ_{b}∇ₛφ, (6)

where:

$${∇}_{s} = \frac{\partial }{\partial a} \hat{a} + \frac{\partial }{\partial b} \hat{b} = ( cos α \frac{\partial }{\partial x} + sin α \frac{\partial }{\partial y} ) \hat{a} + ( - sin α cos β \frac{\partial }{\partial x} + cos α cos β \frac{\partial }{\partial y} + sin β \frac{\partial }{\partial z} ) \hat{b} , \qquad ( 7 )$$

ĉ is a unit vector ĉ=â×\hat{b}, the divergence-free term ∇ₛ×(ĉψ) represents the induction currents, and the curl-free term iωμ₀σ_{b}∇ₛφ represents the conduction currents. Since induction currents exist only on the thin sheet and are defined only by the derivatives of ψ, one is free to set ψ=0 at the edges of the thin sheet. The Green's tensor is similarly separated as:

$${\hat{G}}_{s} ( {r}^{′} , r ) = S + \frac{1}{i {ωμ}_{0} {σ}_{b}} {∇}_{s} Φ , \qquad ( 8 )$$

where the terms S and ∇ₛ [symbol] are determined in the background conductivity model using appropriate boundary conditions in accordance with known methods.

Consider the integral from equation (6):

$${\int }_{A} {\hat{G}}_{s} ( {r}^{′} , r ) \cdot {J}^{s} ( r ) dA = {\int }_{A} [ S + \frac{1}{i {ωμ}_{0} {σ}_{b}} {∇}_{s} Φ ] \cdot [ {∇}_{s} \times ( \hat{c} ψ ) + i {ωμ}_{0} {σ}_{b} {∇}_{s} ϕ ] dA , \qquad ( 9 )$$

in particular, the term:

$$\frac{1}{i {ωμ}_{0} {σ}_{b}} {\int }_{A} {∇}_{s} Φ [ {∇}_{s} \times ( \hat{c} ψ ) ] dA = \frac{1}{i {ωμ}_{0} {σ}_{b}} {\int }_{A} \frac{\partial Φ}{\partial a} \frac{\partial ψ}{\partial b} - \frac{\partial Φ}{\partial b} \frac{\partial ψ}{\partial a} dA = \frac{1}{i {ωμ}_{0} {σ}_{b}} {\int }_{A} [ \frac{\partial }{\partial b} ( ψ \frac{\partial Φ}{\partial a} ) - \frac{\partial }{\partial a} ( ψ \frac{\partial Φ}{\partial b} ) ] dA ,$$

which is reduced to a series of line integrals around the edges of the thin sheets. Since ψ=0 was defined at the edges of the thin sheets earlier, then this integral term reduces to zero for all finite σ_{b}. It follows that equation (9) reduces to:

∫_{A}Ĝₛ(r′,r)·J^{s}(r)dA=∫_{A}{[S·∇ₛ×(\hat{c}ψ)]+[∇ₛ×(\hat{c}ψ)+iωμ₀σ_{b}S+∇ₛ [symbol] . ·∇ₛφ}dA (10)

A similar result can be achieved for a background conductivity model defined by either uniaxial or biaxial anisotropy.

Equation (10) can be discretized as a linear system of equations by dividing all of the thin sheets into a number of cells, where each cell can be of constant conductance, and solving for ψ and φ at each nodal point of the cells; the size of each cell being small enough to assume that the electric field is constant in the cell. At first glance, the total number of unknowns is larger than the number of linear equations. From the definitions of the potentials, for example, ψ=0 at the edges of the thin sheet, and the use of their gradients, the total number of unknowns becomes equal to the number of linear equations.

In alternative embodiments of thin sheet modeling, equation (6) can be approximated by assuming that the scattering currents on the thin sheets are linearly proportional to the background electric fields, that is,

E^{s}(r)=\hat{k}(r)E^{b}(r), (11)

where \hat{k}(r) is a 2×2 tensor whose terms can be defined through analytical or numerical mechanisms. For example, with \hat{k}(r) reduced to a scalar, the electric field becomes:

E^{s}(r)=kE^{b}(r), (12)

and k solved for as a quasi-analytical function. Alternatively, k can be reduced to zero for the Born approximation. In alternative embodiments of thin sheet modeling, equation (6) can be approximated from a spectral decomposition of the scattering tensor. The electric and/or magnetic fields at the receivers can then be computed using discrete forms of equations (2) and (3), whereby the volume integrals of the whole-space terms of the Green's functions can be evaluated analytically, and the volume integrals of the layered-earth terms of the Green's functions can be evaluated numerically.

Once the magnetic fields have been computed at the receiver positions from equation (3), any transfer functions for the MCI tool can be evaluated. The sensitivities of the measured magnetic fields to the different model parameters can be evaluated semi-analytically (for example, for the conductivities of each layer), or by perturbation (for example, for geometric parameters such as layer thickness, thin sheet position, depth, strike, dip, plunge, and/or conductance).

EM data can be acquired over long logging profiles. For a given measurement position, EM logging systems have a limited volume of sensitivity. Hence, there is no need to compute the EM fields for the entire earth model, but rather, only from a subset of the earth model. A technique of a moving window has been applied to the inversion of induction logging. The sensitivities for the selected model parameters in a single window can be assembled into a sensitivity matrix for at least one window, and the earth model within the at least one window updated per standard linearized inversion methods such as, but not limited to, conjugate gradient methods or Gauss-Newton methods. For a given inversion, the number of model parameters is reasonably small compared to the number of data. Typically, this means that the number of data is larger than the number of model parameters. To provide an optimal and stable solution to this problem, a sensitivity matrix can be generated with a Gauss-Newton method.

The properties of model parameters can be constrained within physically realistic values. In some embodiments, the fracture dip can be estimated a priori from electrical or acoustic borehole images. If the fracture thicknesses are known or estimated, the fluid conductivity can be estimated from the conductances of the thin sheets. For example, the fracture thicknesses can be obtained from electrical or acoustic borehole images or from microseismic interpretations. In some embodiments, the fluid types, for example water or oil, filling the fractures can be estimated from dielectric analyses of the complex conductances of the thin sheets.

Methods similar to or identical to methods taught herein can be applied to a number of applications. One or more methods or variations thereof can be applied for the joint (simultaneous) inversion of layered earth and thin sheet model parameters. One or more methods or variations thereof can be applied for the joint (simultaneous) inversion of layered earth and thin sheet model parameters following the initial inversion of whole-space or layered earth model parameters. One or more methods or variations thereof can be applied for the subsequent inversion of thin sheet model parameters following the initial inversion of layered earth model parameters.

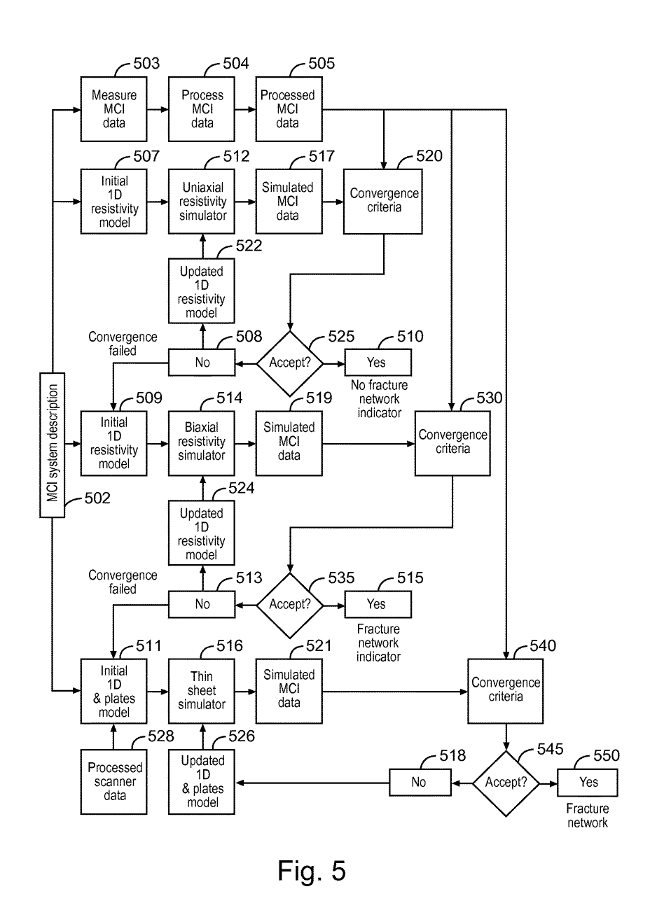

FIG. 5 is a flow diagram of an embodiment of a generalized inversion workflow for generating fracture network indicators. The inversion workflow cascades from a 1D uniaxial resistivity inversion to a 1D biaxial resistivity inversion to a multiple thin sheets inversion as inversion convergence criteria are not satisfied. The 1D earth model can be a whole space or layered earth model, and can contain isotropic, uniaxial anisotropic, or bi-anisotropic conductivities.

In the features of the flow diagram of FIG. 5, a 1D inversion may first consist of a uniaxial anisotropic inversion. For those sections of the log where the uniaxial anisotropic inversion performed poorly (e.g., high misfit, slow convergence, etc.), the 1D inversion may be re-run with a biaxial anisotropic inversion to obtain a fracture network indicator. For those sections of the log where the biaxial anisotropic inversion performed poorly (e.g., high misfit, slow convergence, etc.), a thin sheet can be included in the model at the approximate position, dip and thickness inferred from the biaxial anisotropic inversion and/or electrical or acoustic borehole imaging, and then re-run with the thin sheet inversion with either a uniaxial or a biaxial anisotropic background conductivity model. More than one sheet can be included in the model. The thin sheet(s) can then be interpreted for fracture or fracture network parameters, for example fluid types.

At 502, MCI system description data is generated. MCI system description data can comprise distances between transmitters and receivers, frequencies, and data acquisition parameters—such as gains, offsets or any other transformation. At 503, measured MCI data is acquired and the MCI data is processed at 504, providing processed MCI data at 505. Processing MCI data can include, but is not limited to, removing borehole effects. At 507, an initial 1D resistivity model is generated from the MCI system description data generated at 502 and is applied to a uniaxial resistivity simulator at 512. Results from the uniaxial resistivity simulator are provided as simulated MCI data at 517. At 520, convergence criterion with respect to the processed MCI data and the simulated MCI data is applied. The convergence criterion can include one or more criteria such as one or more misfit criteria. At 525, a decision to accept or not accept the results of applying the convergence criterion at 520 is generated. At 510, if the decision is a yes, a no fracture network indicator can be generated. At 508, if the decision is a no, the ID resistivity model can be updated at 522 and provided to the uniaxial resistivity simulator at 512 to again provide simulated MCI data for application of the convergence criterion with respect to the processed MCI data from measurements. The additional application of the convergence criterion can result in a yes acceptance at 510 or a no acceptance at 508 for continued processing. Rather than further processing with respect to uniaxial simulation, the failed convergence can be used to initiate a biaxial simulation from the no acceptance at 508.

At 509, an indication of the failed convergence from 508 can be received to consider the initial 1D resistivity model from the MCI system description data generated at 502. The initial 1D resistivity model, activated at 509 from the failed convergence from 508, can be input to a biaxial resistivity simulator at 514 that provides simulated MCI data at 519. At 530, convergence criterion is applied with respect to the processed MCI data and the simulated MCI data from the biaxial resistivity simulator at 514. The convergence criterion can include one or more criteria such as one or more misfit criteria. At 535, a decision to accept or not accept the results of applying the convergence criterion at 530 is generated. At 515, if the decision is a yes, a fracture network indicator can be generated. At 513, if the decision is a no, the ID resistivity model can be updated at 524 and provided to the biaxial resistivity simulator at 514 to again provide simulated MCI data for application of the convergence criterion with respect to the processed MCI data from measurements. The additional application of the convergence criterion can result in a yes acceptance at 515 or a no acceptance at 513 for continued processing. Rather than further processing with respect to biaxial simulation, the failed convergence can be used to initiate a thin sheet simulation from the no acceptance at 513.

A plate model is another description of a 1D resistivity model with one or more thin sheets superimposed upon it. With a thin sheet represented as an electrically thin sheet of zero thickness, in terms of EM response, thickness can be manifested through the conductance (conductivity×thickness) assigned as a property of the thin sheet. At 511, processed scanner data from 528, an indication of the failed convergence from 513, and the MCI system description data provided at 502 can be received to generate an initial 1D resistivity and plate model. Processed scanner data can be provided by any borehole imaging method that produces a scanned image of the formation wall in a borehole. Such a scanned image may be based on, but not limited to acoustic methods (e.g., acoustic scanners), dielectric methods (e.g., dielectric scanner), or resistivity methods (e.g., micro-resistivity imaging). There are existing wireline and/or LWD products available in the industry.

The initial 1D resistivity and plates model, activated at 511 from the failed convergence from 513, can be input to a thin sheet simulator at 516 that provides simulated MCI data at 521. At 540, convergence criterion is applied with respect to the processed MCI data and the simulated MCI data from the thin sheet simulator at 516. The convergence criterion can include one or more criteria such as one or more misfit criteria. At 545, a decision to accept or not accept the results of applying the convergence criterion at 540 is generated. At 550, if the decision is a yes, a fracture network indicator can be generated. At 518, if the decision is a no, the 1D resistivity and plates model can be updated at 526 and provided to the thin sheet simulator at 516 to again provide simulated MCI data for application of the convergence criterion with respect to the processed MCI data from measurements. The additional application of the convergence criterion can result in a yes acceptance at 550 or a no acceptance at 518 for continued processing.

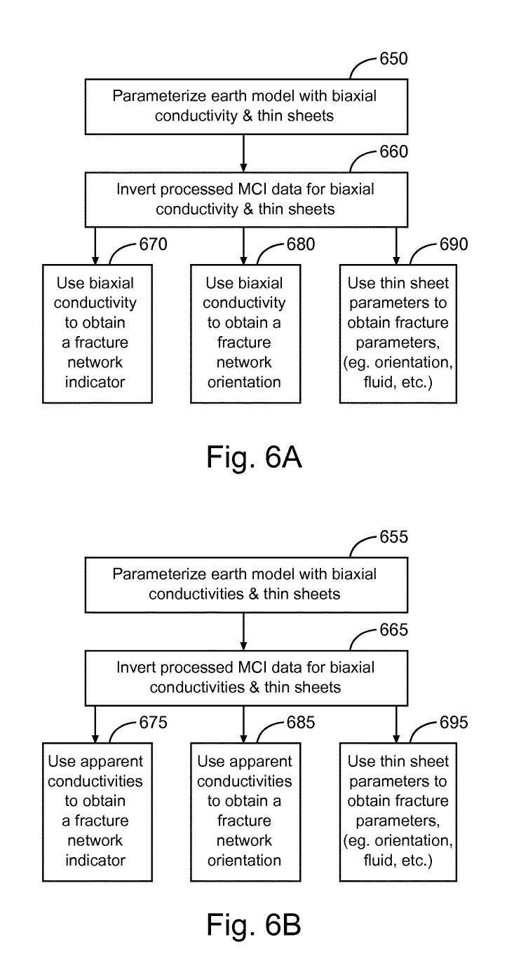

FIGS. 6A-6B are flow diagrams of thin sheet inversions for generating fracture network indicators. In FIG. 6A, a workflow is presented for obtaining the different fracture network indicators from a thin sheet inversion, where an earth model has parameters in terms of biaxial conductivities and thin sheets. At 650, an earth model is parameterized with biaxial conductivity and thin sheets. At 660, processed MCI data is inverted for biaxial conductivity and thin sheets. At 670, biaxial conductivity is used to obtain a fracture network indicator. At 680, biaxial conductivity is used to obtain a fracture network orientation. At 690, thin sheet parameters are used to obtain fracture parameters such as, but not limited to, orientation, fluid, etc.

In FIG. 6B, a workflow is presented for obtaining the different fracture network indicators from a thin sheet inversion, where an earth model has parameters in terms of apparent conductivities and thin sheets. At 655, an earth model is parameterized with apparent conductivities and thin sheets. At 665, processed MCI data is inverted for apparent conductivities and thin sheets. At 675, apparent conductivities are used to obtain a fracture network indicator. At 685, apparent conductivities are used to obtain a fracture network orientation. At 695, thin sheet parameters are used to obtain fracture parameters such as, but not limited to, orientation, fluid, etc.

Methods similar to or identical to processing taught herein can be implemented or applied in number of situations using a variety of measurement components. Such methods may be applied in a joint inversion method for different types of EM data. Such methods may be applied in a joint inversion method for at least one type of EM data and other geophysical (e.g., acoustic) data. Such methods may be applied in real-time or may be applied after data acquisition and processing. Such methods may be implemented in series and/or parallel processing architectures. The parallel processing architectures can include a GPU. Such methods may be implemented with either a stand-alone software or integrated as part of a commercial well logging software (e.g., InSite, DecisionSpace) through an application programmable interface (API). Computational tasks with respect to such methods may be performed at the surface (for example, at the well site) or can be communicated via networks to a remote site (for example, a server farm) with results communicated via network back to the well site. In such methods and corresponding apparatus, the type of EM transmitter used in the EM survey is arbitrary and may include any electric and/or magnetic transmitter types. In addition, the type of EM receiver used in the EM survey is arbitrary, and may include any electric and/or magnetic receiver types such as but not limited to coils, electrodes, and fiber optic sensors. In various embodiments, the fractures can be filled with electromagnetic contrast enhancing agents, such as magnetic nanoparticles, magnetic, conductive, or capacitive fluids and/or particles, to improve fracture detectability. In various embodiments, time-lapse analysis of two or more EM surveys conducted at different times can be performed. This time-lapse analysis can characterize growth from existing fractures, or can characterize new fractures.

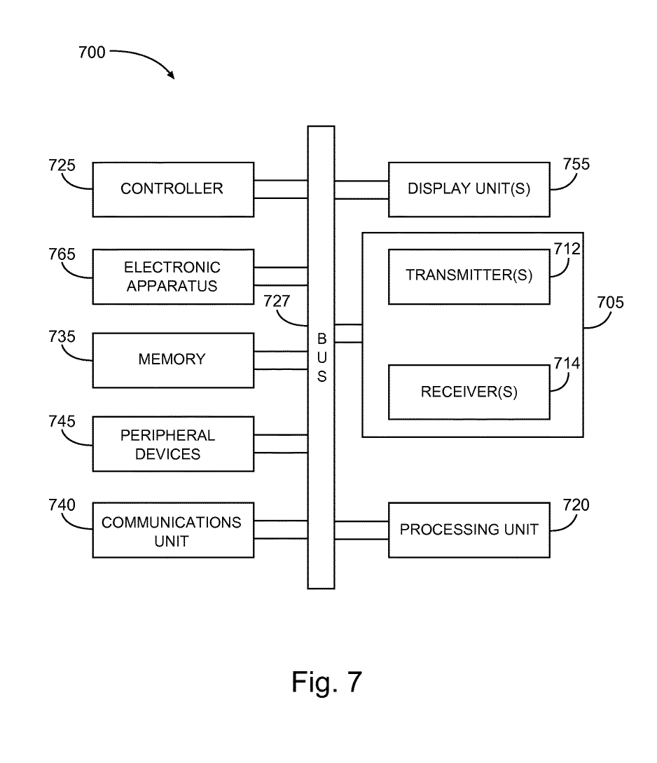

FIG. 7 is a block diagram of features of an embodiment of an example system 700 operable to control an electromagnetic logging tool to conduct measurements in a borehole and to implement a processing scheme to determine a fluid-filled fracture characterization associated with the borehole. The system 700 includes a tool structure 705 having an arrangement of transmitter antenna(s) 712 and receiver antenna(s) 714 operable in a borehole. The arrangements of the transmitter antenna(s) 712 and the receiver antenna(s) 714 of the tool structure 705 can be realized similar to or identical to arrangements discussed herein. The system 700 can also include a controller 725, a memory 735, electronic apparatus 765, and a communications unit 740.

The controller 725 and the memory 735 can be arranged to operate the tool structure 705 to acquire measurement data as the tool structure 705 is operated. The controller 725 and the memory 735 can be realized to control activation of selected ones of the transmitter antennas 712 and data acquisition by selected one of the receiver antennas 714 in the tool structure 705 and to manage processing schemes with respect to data derivable from measurements using tool structure 705 as described herein. In an embodiment, the controller 725 can be realized as one or more processors. Processing unit 720 can be structured to perform the operations to manage processing schemes in a manner similar to or identical to embodiments described herein. Processing unit 720 may include a dedicated processor.

Electronic apparatus 765 can be used in conjunction with the controller 725 to perform tasks associated with taking measurements downhole with the transmitter antenna(s) 714 and the receiver antenna(s) 712 of the tool structure 705. The communications unit 740 can include downhole communications in a drilling operation. Such downhole communications can include a telemetry system.

The system 700 can also include a bus 727, where the bus 727 provides electrical conductivity among the components of the system 700. The bus 727 can include an address bus, a data bus, and a control bus, each independently configured. The bus 727 can also use common conductive lines for providing one or more of address, data, or control, the use of which can be regulated by the controller 725. The bus 727 can be configured such that the components of the system 700 can be distributed. Such distribution can be arranged between downhole components such as the transmitter antenna(s) 712 and the receiver antenna(s) 714 of the tool structure 705 and components that can be disposed on the surface of a well. Alternatively, various of these components can be co-located such as on one or more collars of a drill string or on a wireline structure. The bus 727 may be arranged as part of a communication network allowing communication with control sites situated remotely from system 700.

In various embodiments, peripheral devices 745 can include displays, additional storage memory, and/or other control devices that may operate in conjunction with the controller 725 and/or the memory 735. The peripheral devices 745 can be arranged to operate in conjunction with display unit(s) 755 with instructions stored in the memory 735 to implement a user interface to manage the operation of the tool structure 705 and/or components distributed within the system 700. Such a user interface can be operated in conjunction with the communications unit 740 and the bus 727. Various components of the system 700 can be integrated with the tool structure 705 such that processing identical to or similar to the processing schemes discussed with respect to various embodiments herein can be performed downhole in the vicinity of the measurement or at the surface.

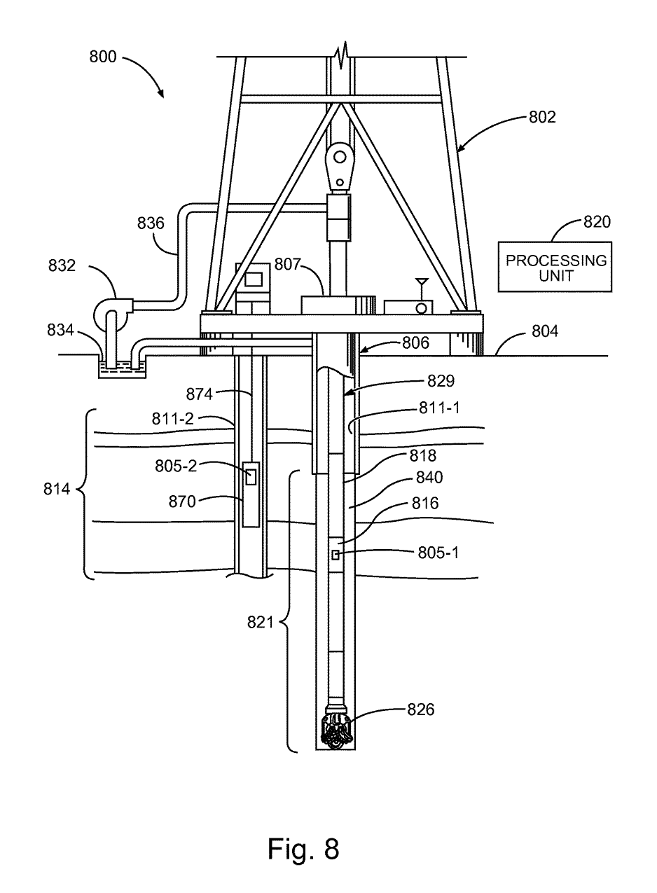

FIG. 8 is a schematic diagram of an embodiment of an example system 800 at a drilling site, where the system 800 is operable to control an electromagnetic logging tool to conduct measurements in a borehole and to implement a processing scheme to determine a fluid-filled fracture characterization associated with the borehole. The system 800 can include a tool 805-1, 805-2, or both 805-1 and 805-2 having an arrangement of transmitter antennas and receiver antennas operable to make measurements that can be used for a number of drilling tasks including, but not limited to, processing data to determine a fluid-filled fracture characterization associated with the borehole. The tools 805-1 and 805-2 can be structured identical to or similar to a tool architecture or combinations of tool architectures discussed herein, including control units and processing units operable to perform processing schemes in a manner identical to or similar to processing techniques discussed herein. The tools 805-1, 805-2, or both 805-1 and 805-2 can be distributed among the components of system 800. The tools 805-1 and 805-2 can be realized in a similar or identical manner to arrangements of control units, transmitters, receivers, and processing units discussed herein. The tools 805-1 and 805-2 can be structured and fabricated in accordance with various embodiments as taught herein.

The system 800 can include a drilling rig 802 located at a surface 804 of a well 806 and a string of drill pipes, that is, drill string 829, connected together so as to form a drilling string that is lowered through a rotary table 807 into a wellbore or borehole 811-1. The drilling rig 802 can provide support for the drill string 829. The drill string 829 can operate to penetrate rotary table 807 for drilling the borehole 811-1 through subsurface formations 814. The drill string 829 can include a drill pipe 818 and a bottom hole assembly 821 located at the lower portion of the drill pipe 818.

The bottom hole assembly 821 can include a drill collar 816 and a drill bit 826. The drill bit 826 can operate to create the borehole 811-1 by penetrating the surface 804 and the subsurface formations 814. The bottom hole assembly 821 can include the tool 805-1 attached to the drill collar 816 to conduct measurements to determine formation parameters. The tool 805-1 can be structured for an implementation as a MWD system such as a LWD system. The housing containing the tool 805-1 can include electronics to initiate measurements from selected transmitter antennas and to collect measurement signals from selected receiver antennas. Such electronics can include a processing unit to provide analysis of data for fracture characterization over a standard communication mechanism for operating in a well. Alternatively, electronics can include a communications interface to provide measurement signals collected by the tool 805-1 to the surface over a standard communication mechanism for operating in a well, where these measurements signals can be analyzed at a processing unit 820 at the surface to provide analysis of data for fracture characterization.

During drilling operations, the drill string 829 can be rotated by the rotary table 807. In addition to, or alternatively, the bottom hole assembly 821 can also be rotated by a motor (e.g., a mud motor) that is located downhole. The drill collars 816 can be used to add weight to the drill bit 826. The drill collars 816 also can stiffen the bottom hole assembly 821 to allow the bottom hole assembly 821 to transfer the added weight to the drill bit 826, and in turn, assist the drill bit 826 in penetrating the surface 804 and the subsurface formations 814.

During drilling operations, a mud pump 832 can pump drilling fluid (sometimes known by those of skill in the art as “drilling mud”) from a mud pit 834 through a hose 836 into the drill pipe 818 and down to the drill bit 826. The drilling fluid can flow out from the drill bit 826 and be returned to the surface 804 through an annular area 840 between the drill pipe 818 and the sides of the borehole 811-1. The drilling fluid may then be returned to the mud pit 834, where such fluid is filtered. In some embodiments, the drilling fluid can be used to cool the drill bit 826, as well as to provide lubrication for the drill bit 826 during drilling operations. Additionally, the drilling fluid may be used to remove subsurface formation cuttings created by operating the drill bit 826.

In various embodiments, the tool 805-2 may be included in a tool body 870 coupled to a logging cable 874 such as, for example, for wireline applications. The tool body 870 containing the tool 805-2 can include electronics to initiate measurements from selected transmitter antennas and to collect measurement signals from selected receiver antennas. Such electronics can include a processing unit to provide analysis of data for fracture characterization over a standard communication mechanism for operating in a well. Alternatively, electronics can include a communications interface to provide measurement signals collected by the tool 805-2 to the surface over a standard communication mechanism for operating in a well, where these measurements signals can be analyzed at the processing unit 820 at the surface to provide analysis of data for fracture characterization. The logging cable 874 may be realized as a wireline (multiple power and communication lines), a mono-cable (a single conductor), and/or a slick-line (no conductors for power or communications), or other appropriate structure for use in the borehole 811-2. Though FIG. 8 depicts both an arrangement for wireline applications and an arrangement for LWD applications, the system 800 may be structured to provide one of the two applications.

In various embodiments, system processing may include techniques that describe a fluid-filled fracture as an electrically thin sheet of arbitrary size, orientation, and conductance, embedded in formation, where the formation may be described as a layered medium with each layer of the layered medium characterized by an anisotropic, frequency-dependent conductivity. Fluid-filled fractures near a borehole can be characterized with respect to thin sheets, and can be interpreted for properties such as fracture position, size, strike, dip, and plunge, measured with respect to the borehole. From the conductance of the fracture, the conductivity and/or thickness of the fracture can be estimated. Such processing can provide a model to describe fluid-filled fractures in a manner that is more physically realistic than conventional processes. The properties of the fluid-filled fractures and the formation can be inverted simultaneously or separately using the thin sheet approach taught herein. Processing similar to or identical to processing taught herein can be applied to any EM logging data, including open-hole wireline, through-casing resistivity, and/or LWD EM data. Such processing can be integrated with other fracture diagnostic tools and methods, for example, with acoustic tools and methods. In addition, such processing can be applied in real-time.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description. Combinations of the above embodiments and other embodiments will be apparent to those of skill in the art upon studying the above description.

1. A method of processing earth formation related data, the method comprising:
acquiring data from operating an electromagnetic logging tool in a borehole;
processing the data;
applying an earth model and a thin sheet fracture model such that a fracture is represented by an electrically thin sheet of zero thickness; and
generating a property of the fracture based on the processed data and the application of the earth model and the thin sheet fracture model.

2. The method of claim 1, further comprising:
generating at least one of a fracture network indicator and properties of the fracture network, the fracture network including the fracture.

3. The method of claim 1, further comprising:
in each of a number of iterations, comparing the processed data and an iterative result of applying the earth model and the thin sheet fracture model with respect to a convergence criterion,
wherein applying the earth model and the thin sheet fracture model includes cascading stages from a one-dimensional resistivity inversion to a one-divisional biaxial resistivity inversion to a multiple thin sheets inversion based on results of comparison with convergence criterion in each of the stages.

4. (canceled)

5. The method of claim 1, further comprising:
parameterizing the earth model and the thin sheet fracture model with respect to one or more biaxial conductivities or one or more apparent conductivities and with respect to one or more electrically thin sheets, each electrically thin sheet represented having zero thickness; and
inverting the processed data for the parameterized earth model and the thin sheet fracture model.

6. The method of claim 5, wherein inverting includes simultaneous inversion with respect to the parameterized earth model and the thin sheet fracture model or sequential inversion with inversion with respect to the parameterized earth model followed by inversion with respect to the thin sheet fracture model.

7. The method of claim 1, wherein generating the property of the fracture includes estimating at least one of conductivity of the fracture, thickness of the fracture, dip angle of the fracture, and azimuthal orientation of the fracture.

8. The method of claim 1, wherein applying the thin sheet fracture model includes at least one of the following:
dividing one or more thin sheets into a number of cells, each cell of constant conductance and each thin sheet representing a fracture;
using processed data and applying the earth model and the thin sheet fracture model for a window of a selected volume of the earth model, wherein using processed data and applying the earth model and the thin sheet fracture model for the window of the selected volume of the earth model includes performing an inversion;
applying a one-dimensional whole-space earth model or a one-dimensional layered earth model, the earth model containing at least one of an isotropic conductivity, a uniaxial anisotropic conductivity, and a bi-anisotropic conductivity; and
applying the earth model and the thin sheet fracture model according to surface integrals using a spectral technique.

9. The method of claim 1, further comprising:
identifying a number of fractures using the thin sheet fracture model; and
estimating one or more fluid types in each fracture of the number of fractures based on dielectric analyses of a complex conductance of each sheet representing a fracture.

10-13. (canceled)

14. The method of claim 1, further comprising:
operating the electromagnetic logging tool in the borehole with an electromagnetic contrast enhancing agent filling a number of fractures probed, providing data included in the acquired data.

15. The method of claim 1, further comprising:
performing a time-lapse analysis on the acquired data, the acquired data including data from two or more electromagnetic surveys conducted in the borehole at different times.

16-32. (canceled)

33. A system comprising:
an electromagnetic logging tool to operate in a borehole,
a processor; and
a machine-readable medium having program code executable by the processor to cause the processor to,
acquire data from operating the electromagnetic logging tool in the borehole;
process the data;
apply an earth model and a thin sheet fracture model such that a fracture is represented by an electrically thin sheet of zero thickness; and
generate a property of the fracture based on the processed data and the application of the earth model and the thin sheet fracture model.

34. The system of claim 33, wherein the program code comprises program code executable by the processor to cause the processor to generate at least one of a fracture network indicator and properties of the fracture network, the fracture network including the fracture.

35. The system of claim 33,
wherein the program code comprises program code executable by the processor to cause the processor to, in each of a number of iterations, compare the processed data and an iterative result of application of the earth model and the thin sheet fracture model with respect to a convergence criterion, and
wherein the program code executable by the processor to cause the processor to apply the earth model and the thin sheet fracture model comprises program code executable by the processor to cause the processor to cascade of stages from a one-dimensional resistivity inversion to a one-divisional biaxial resistivity inversion to a multiple thin sheets inversion based on results of comparison with convergence criterion in each of the stages.

36. (canceled)

37. The system of claim 33, wherein the program code comprises program code executable by the processor to cause the processor to:
parameterize the earth model and the thin sheet fracture model with respect to one or more biaxial conductivities or one or more apparent conductivities and with respect to one or more electrically thin sheets, each electrically thin sheet represented having zero thickness; and
invert the processed data for the parameterized earth model and the thin sheet fracture model either simultaneously or sequentially with execution of the program code to cause the processor to parameterize of the earth model and the thin sheet fracture model.

38. (canceled)

39. The system of claim 33, wherein the program code executable by the processor to cause the processor to generate the property of the fracture comprises program code executable by the processor to cause the processor to estimate at least one of conductivity of the fracture, thickness of the fracture, dip angle of the fracture, and azimuthal orientation of the fracture.

40. The system of claim 33, wherein the program code executable by the processor to cause the processor to apply the earth model and the thin sheet fracture model comprises program code executable by the processor to cause the processor to perform at least one of,
divide of one or more thin sheets into a number of cells, each cell of constant conductance and each thin sheet representing a fracture;
use processed data and apply the earth model and the thin sheet fracture model for a window of a selected volume of the earth model, wherein the program code executable by the processor to cause the processor to use processed data and apply the earth model and the thin sheet fracture model comprises program code executable by the processor to cause the processor to perform an inversion;
apply at least one of a one-dimensional whole-space earth model and a one-dimensional layered earth model, the earth model containing at least one of an isotropic conductivity, a uniaxial anisotropic conductivity, and a bi-anisotropic conductivity; and
apply the earth model and the thin sheet fracture model according to surface integrals using a spectral technique.

41. The system of claim 33, wherein the program code comprises program code executable by the processor to cause the processor to:
identify a number of fractures using the thin sheet fracture model; and
estimate one or more fluid types in each fracture of the number of fractures based on dielectric analyses of a complex conductance of each sheet representing a fracture.

42-45. (canceled)

46. The system of claim 33, wherein the program code comprises program code executable by the processor to cause the processor to operate the electromagnetic logging tool in the borehole with an electromagnetic contrast enhancing agent filling a number of fractures probed, providing data included in the acquired data.

47. The system of claim 33, wherein the program code comprises program code executable by the processor to cause the processor to perform a time-lapse analysis on the acquired data, the acquired data including data from two or more electromagnetic surveys conducted in the borehole at different times.

48. (canceled)

49. The system of claim 33, wherein the electromagnetic logging tool includes a multi-component induction tool having a transmitter array and a plurality of receiver arrays.

50. (canceled)
